(19) United States
(12) Patent Application Publication
(10) Pub. No.: US 2016/0205641 A1
(43) Pub. Date: Jul. 14, 2016

(54) ANONYMOUS NOTIFICATION MESSAGE GENERATOR

(71) Applicant: International Business Machines Corporation, Armonk, NY (US)

(72) Inventors: Tamer E Abuelsaad, Somers, NY (US); John Maxwell Cohn, Richmond, VT (US); David Wayne Harrison, Patterson, NY (US); Brent Hodges, Raleigh, NC (US); John Elbert Moore, JR., Brownsburg, IN (US)

(21) Appl. No.: 14/596,557

(22) Filed: Jan. 14, 2015

(51) Int. Cl. H04W 56/00; H04W 76/02; H04W 4/12; H04W 68/00

(52) U.S. Cl. CPC H04W 56/00; H04W 68/005; H04W 76/023; H04W 4/12

(57) ABSTRACT

A method includes synchronizing a portable device with a receiver device; storing contact information regarding the receiver device on said portable device; deploying said portable device remotely from the receiver device; and causing said portable device to transmit said contact information and a predetermined message as a result of a triggering action.

### BACKGROUND

The present invention relates to sending messages to receiver devices, and more specifically, to sending anonymous notification messages to a receiver device as the result of a triggering action.

Today there are times when a person needs to be contacted by someone they don't know and they don't want to hand out their mobile number. One example might be when a consumer has dropped their car off for a tire change and then has gone into the mall to get some shopping done. The owner of the car does not want their name broadcast throughout the store or mall stating their car is ready or to provide their mobile number to receive a call or text stating that the car is ready. Instead, they may want a more anonymous way of knowing their car is ready.

### SUMMARY

According to one aspect of the present invention, a method includes synchronizing a portable device with a receiver device; storing contact information regarding the receiver device on said portable device; deploying said portable device remotely from the receiver device; and causing said portable device to transmit said contact information and a predetermined message as a result of a triggering action.

According to another aspect of the present invention, a system includes: one or more processors, one or more computer-readable memories and one or more computer-readable, tangible storage devices; a synchronizing module operatively coupled to at least one of the one or more storage devices for execution by at least one of the one or more processors via at least one of the one or more memories, configured to synchronize a portable device with a receiver device; a storing module operatively coupled to at least one of the one or more storage devices for execution by at least one of the one or more processors via at least one of the one or more memories, configured to store contact information regarding the receiver device on said portable device; a deploying module operatively coupled to at least one of the one or more storage devices for execution by at least one of the one or more processors via at least one of the one or more memories, configured to deploy said portable device remotely from the receiver device; and an action module operatively coupled to at least one of the one or more storage devices for execution by at least one of the one or more processors via at least one of the one or more memories, configured to cause said portable device to transmit said contact information and a predetermined message as a result of a triggering action.

According to yet another aspect of the present invention, a computer program product including: one or more computer-readable, tangible storage medium; program instructions, stored on at least one of the one or more storage medium, to synchronize a portable device with a receiver device; program instructions, stored on at least one of the one or more storage medium, to store contact information regarding the receiver device on said portable device; program instructions, stored on at least one of the one or more storage medium, to deploy said portable device remotely from the receiver device; and program instructions, stored on at least one of the one or more storage medium, to cause said portable device to transmit said contact information and a predetermined message as a result of a triggering action.

### BRIEF DESCRIPTION OF THE SEVERAL VIEWS OF THE DRAWINGS

FIG. 1 shows a flowchart according to an embodiment of the present invention.

FIGS. 2A and 2B show exemplary implementation according to an embodiment of the present invention.

FIG. 3 shows another exemplary implementation according to an embodiment of the present invention.

FIG. 4 shows still another exemplary implementation according to an embodiment of the present invention.

FIG. 5 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

The creation of an inexpensive device that can be handed out and reused notifies its intended originator without providing any personal contact information will now be described.

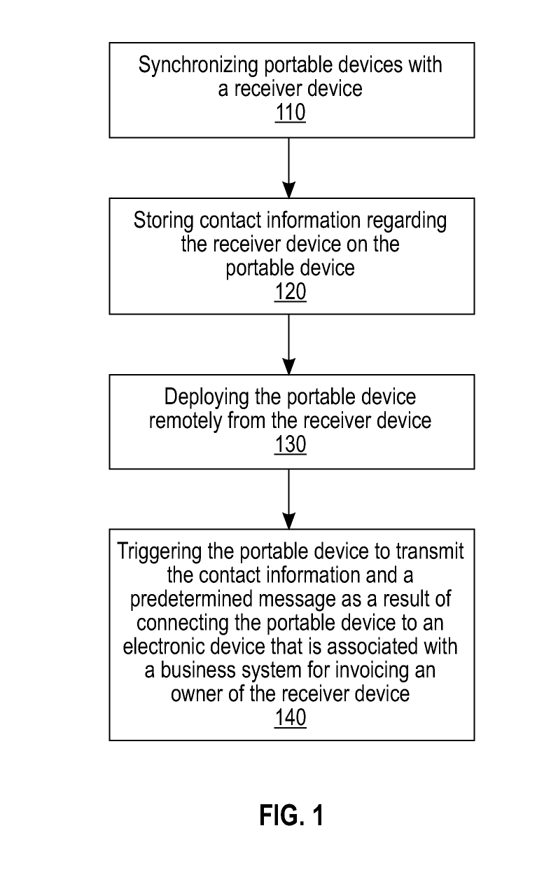

Now referring to FIG. 1, an embodiment of the present invention includes the process of synchronizing portable devices with a receiver device (110). After synchronization, the process stores contact information regarding the receiver device on the portable device (120). The portable device is then deployed remotely from the receiver device (130). The process then continues with triggering the portable device to transmit the contact information and a predetermined message as a result of connecting the portable device to an electronic device that is associated with a business system for invoicing an owner of the receiver device (140). The triggering of the portable device indicates that the contracted work has been completed and the owner is notified via their personal receiver device. The receiver device may be a cell phone or another personal device. The anonymous notification and message may be transmitted as a short message service (SMS) or sent as an email.

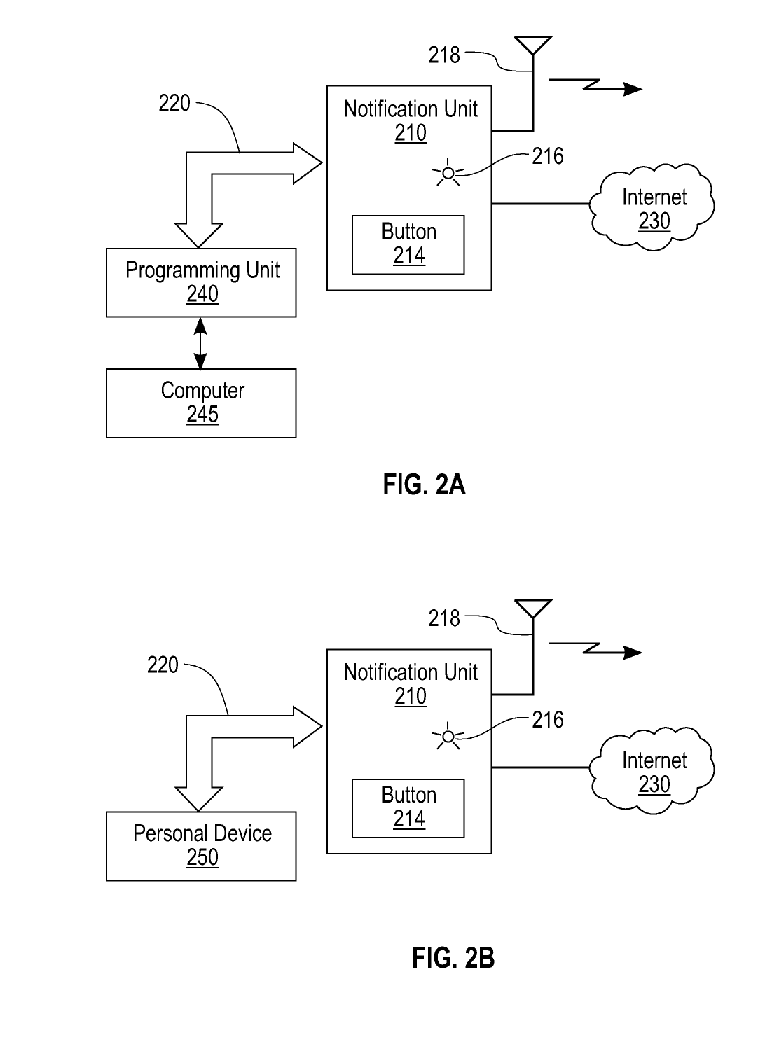

Referring to FIGS. 2A and 2B, exemplary implementations according to embodiments of the present invention are depicted. A portable notification unit 210 includes connections 220 for connecting to a programming/synchronization system. One programming/synchronization system includes a programming unit 240 and a computer 245. Another programming/synchronization system includes a mobile personal device 250 such as a cell phone or another mobile computing device. The function of the programming/synchronization system is too pair the portable notification unit 210 with a personal receiver device (not shown). The pairing involves loading the portable notification unit 210 with electronic addressing means to contact the personal receiver device. The portable notification unit 210 further includes means for storing and sending a predetermined message to personal receiver device. The means for contacting and sending the message to the personal receiver device includes an antenna 215 which is in radio communications with either a cellular system or WIFI. Additional methods for contacting and sending the message to the personal receiver device includes elements for physically connecting to the internet 230.

Still referring to FIGS. 2A and 2B, the portable notification unit 210 optionally includes a manual button 214 and a visual indicator 216. The manual button 214 can be used to start the programming/synchronization process when the portable notification unit 210 is connected with either the programming unit 244 or the personal device 250. The manual button 214 can also be used for contacting and sending the message to the personal receiver device after synchronization and remote deployment have occurred. The visual indicator 216 indicates the standby, the programming/synchronization and the message notification states.

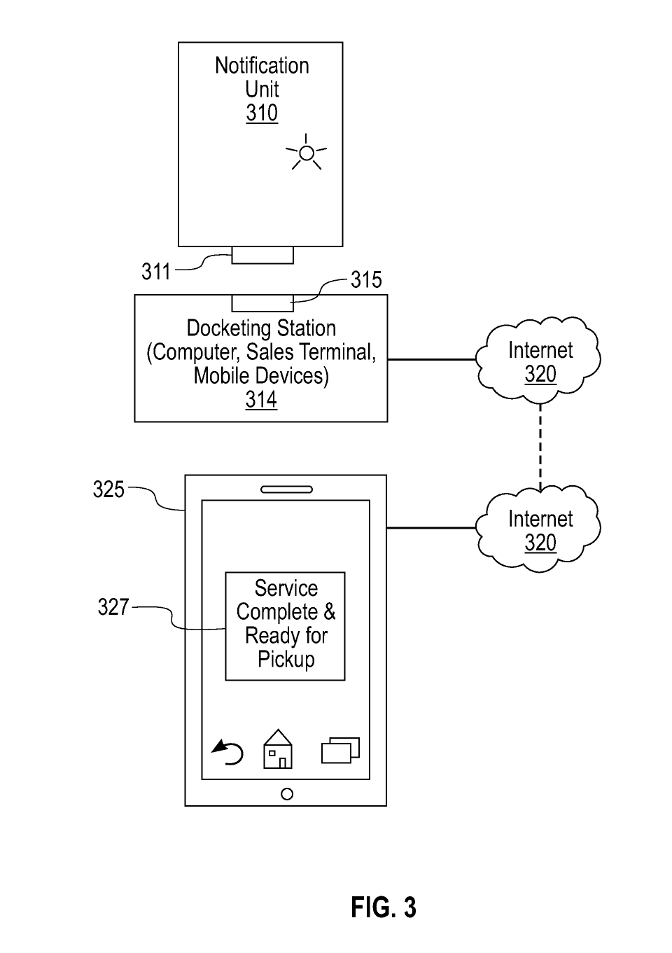

Referring to FIG. 3, an exemplary implementation according to embodiments of the present invention is depicted. A portable notification unit 310 which has been remotely deployed after synchronization is ready for sending a notification message to a personal device 325. After a completed task has been done, the notification unit 310 is connected to a docketing station 314 via connectors (311, 315). The docketing station 314 may be part of computer sales terminal or mobile device for invoicing or those offering proposed services. The notification message may be follow-up information about products or services. For example owners of the portable device 325 may have handled out the notification unit(s) 310 at a trade show, sales convention or health care provider offices. Once connected, the notification unit 310 contacts and sends a predetermined message 327 to the portable device 325 via the internet 320. A key feature of the present invention allows for the contact information of the portable device 325 to remain anonymous from the business conducting the contracted work or those offering proposed services.

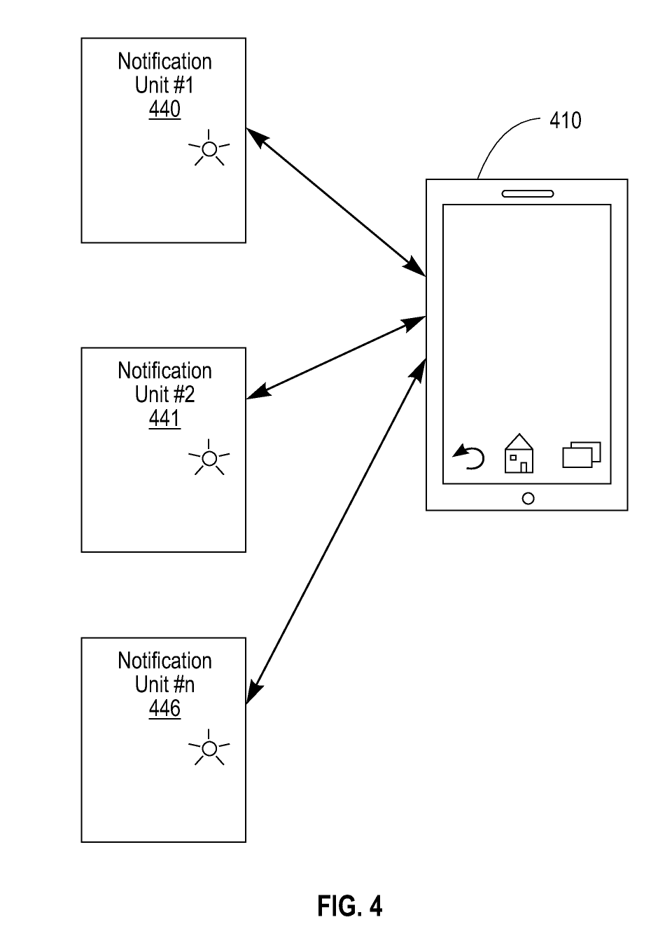

Referring to FIG. 4, still another exemplary implementation according to embodiments of the present invention is depicted. In one implementation an owner of the personal device 410 has the ability to be in contact with multiple notification units (440, 441 and 446). Each of the notification units (440, 441 and 446), when remotely deployed, can contact and send a predetermined message to the portable device 410. It should be noted that each of the notification units (440, 441 and 446) can be associated with different contracted work items.

The following describes possible examples for embodiments of the present invention:

### Example 1

Key fob style which is a re-useable device and uses it as follows:
1. The consumer would purchase a few of these ‘matched’ devices and personalize them by plugging them into the USB or pairing the Bluetooth of the smart phone. Alternatively, these devices could be synchronized to the traditional cell phone via an application on the consumer's home desktop or laptop computer. The instructions in the package of ‘matched’ devices would provide a variety of these methods.
2. The consumer could carry a few of these activated devices with him/her while shopping or running errands.
3. On each leg of a multi-visit trip the consumer would leave one with each vendor.
4. When the consumer enters into an agreement with the vendor or provider of service, to receive/purchase the product or valuable service, the consumer provides the vendor or provider of service with one of these devices.
5. Once the vendor has completed the preparation or installation of the product or valuable service, the vendor triggers the activation of the device by merely plugging it into or pairing with Bluetooth of their own smart phone or the USB port of the retail system computerized register (which is typically a small desktop).
6. The device transmits the vendor's business information or phone number which calls the customer to inform them that their product is ready to be picked up or valuable services are complete.

### Example 2

A model is a business which purchases a number of matched and logo'd key fobs which are re-useable devices and uses them as follows:
1. The business would purchase a number of these ‘matched’ devices, imprinted with their logo and personalize them by plugging them into the USB of the business smart phone. Alternatively, these devices could be synchronized to the traditional land line of the business via an application on the business' office desktop or laptop computer. The instructions in the package of ‘matched’ devices would provide a variety of these methods.
2. The business keeps a stock of these personalized devices for anonymous communication with customers.
3. When the consumer enters into an agreement with the business, to receive/purchase the business' product or valuable service, the business provides the consumer with one of these devices.
4. Once the business has completed the preparation or installation of the product or valuable service, the business triggers the activation of the device by setting it electronically when the invoice is created or merely plugging it into their own smart phone or the USB port of the retail system computerized register (which is typically a small desktop).
5. The device causes the customer's phone to vibrate or beep to inform the customer that their product or valuable services are ready to be picked up.

Still further embodiments of the present invention may be directed to the following:
1. A potentially disposable device with the capability to communicate with a first individual's (or group of individuals) phone (or other major communication venue/device), where a second individual performs an action on it that causes generation of an alert to first individual's phone device:
Where action performed by second individual is as simple as pressing a button;
Where action performed by second individual is a destructive action such as breaking in half.
2. Pairing/activating of potentially disposable device to individual's phone (or other major communication device) includes:
Using individual's phone to scan QR Code affixed on disposable device and entering a tag to be associated with alerts from the *issued* device.
3. Unpairing/deactivating of potentially disposable device from individual's phone (or other major communication device) includes:
Using individual's phone to scan QR Code affixed on the *issued” device and removing it from a list stored in the individual's phone;
Simple removal of tag associated with disposable device from individual's phone listing of tags.

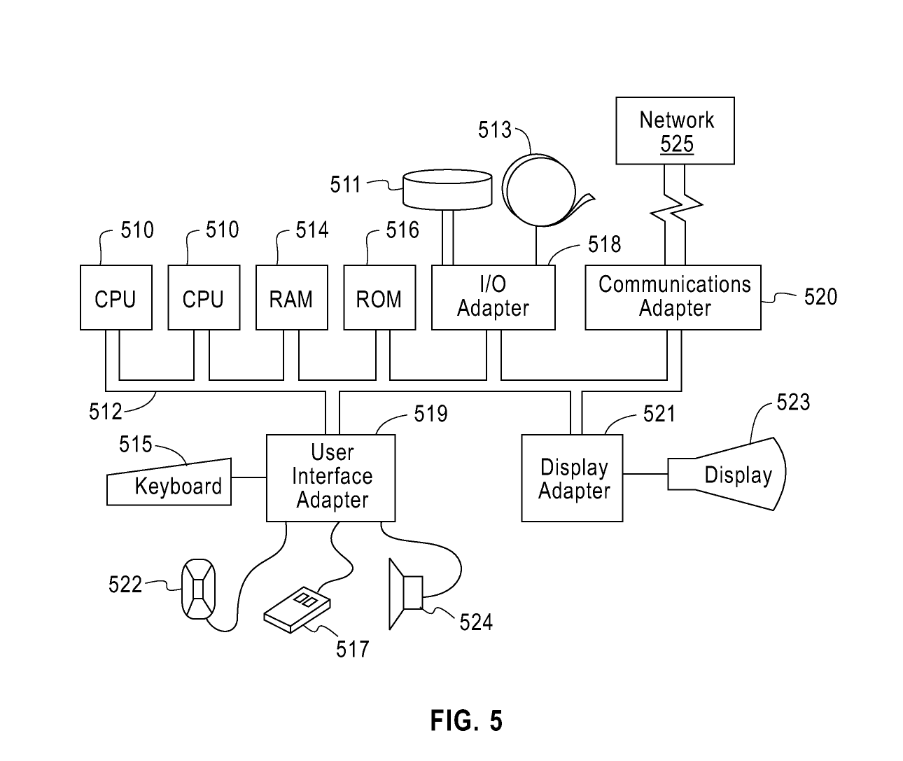

Referring now to FIG. 5, this schematic drawing illustrates a hardware configuration of an information handling/computer imaging system in accordance with the embodiments of the invention. The system comprises at least one processor or central processing unit (CPU) 510. The CPUs 510 are interconnected via system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of the embodiments of the invention. The system further includes a user interface adapter 519 that connects a keyboard 515, mouse 517, speaker 524, docking device 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
synchronizing a portable device with a receiver device;
storing contact information regarding the receiver device on said portable device;
deploying said portable device remotely from the receiver device; and
causing said portable device to transmit said contact information and a predetermined message as a result of a triggering action.

2. The method according to claim 1, wherein the triggering action is based upon the completion of a task.

3. The method according to claim 2, wherein the task completion triggering action is the result of finishing contracted work for an owner of the receiver device.

4. The method according to claim 1, wherein the portable device is reusable after synchronizing with the receiver device.

5. The method according to claim 1, further comprising synchronizing a plurality of portable devices with the receiver device.

6. The method according to claim 1, wherein the triggering action is based upon connecting the portable device to an electronic device.

7. The method according to claim 6, wherein the electronic device is associated with a business system for invoicing an owner of the receiver device.

8. A system comprising:
one or more processors, one or more computer-readable memories and one or more computer-readable, tangible storage devices;
a synchronizing module operatively coupled to at least one of the one or more storage devices for execution by at least one of the one or more processors via at least one of the one or more memories, configured to synchronize a portable device with a receiver device;
a storing module operatively coupled to at least one of the one or more storage devices for execution by at least one of the one or more processors via at least one of the one or more memories, configured to store contact information regarding the receiver device on said portable device;
a deploying module operatively coupled to at least one of the one or more storage devices for execution by at least one of the one or more processors via at least one of the one or more memories, configured to deploy said portable device remotely from the receiver device; and
an action module operatively coupled to at least one of the one or more storage devices for execution by at least one of the one or more processors via at least one of the one or more memories, configured to cause said portable device to transmit said contact information and a predetermined message as a result of a triggering action.

9. The system according to claim 8, wherein the triggering action is based upon the completion of a task.

10. The system according to claim 9, wherein the task completion triggering action is the result of finishing contracted work for an owner of the receiver device.

11. The system according to claim 8, wherein the portable device is reusable after synchronizing with the receiver device.

12. The system according to claim 8, wherein the synchronizing module synchronizes a plurality of portable devices with the receiver device.

13. The system according to claim 8, wherein the triggering action is based upon connecting the portable device to an electronic device.

14. The system according to claim 13, wherein the electronic device is associated with a business system for invoicing an owner of the receiver device.

15. A computer program product comprising:
one or more computer-readable, tangible storage medium;
program instructions, stored on at least one of the one or more storage medium, to synchronize a portable device with a receiver device;
program instructions, stored on at least one of the one or more storage medium, to store contact information regarding the receiver device on said portable device;
program instructions, stored on at least one of the one or more storage medium, to deploy said portable device remotely from the receiver device; and
program instructions, stored on at least one of the one or more storage medium, to cause said portable device to transmit said contact information and a predetermined message as a result of a triggering action.

16. The computer program product according to claim 15, wherein the triggering action is based upon the completion of a task.

17. The computer program product according to claim 16, wherein the task completion triggering action is the result of finishing contracted work for an owner of the receiver device.

18. The computer program product according to claim 15, wherein the portable device is reusable after synchronizing with the receiver device.

19. The computer program product according to claim 15, wherein the triggering action is based upon connecting the portable device to an electronic device.

20. The computer program product according to claim 19, wherein the electronic device is associated with a business system for invoicing an owner of the receiver device.
